(19) United States
(12) Patent Application Publication
(10) Pub. No.: US 2007/0005933 A1
(43) Pub. Date: Jan. 4, 2007

(54) Preventing multiple translation lookaside buffer accesses for a same page in memory

(76) Inventors: Brian Joseph Kopec, Cary, NC (US); Victor Roberts Augsburg, Cary, NC (US); James Norris Dieffenderfer, Apex, NC (US); Jeffrey Todd Bridges, Raleigh, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/174,097

(22) Filed: Jun. 29, 2005

(51) Int. Cl. G06F 12/00

(52) U.S. Cl. 711/207

(57) ABSTRACT

A processor includes a memory configured to store data in a plurality of pages, a TLB, and a TLB controller. The TLB is configured to search, when accessed by an instruction having a virtual address, for address translation information that allows the virtual address to be translated into a physical address of one of the plurality of pages, and to provide the address translation information if the address translation information is found within the TLB. The TLB controller is configured to determine whether a current instruction and a subsequent instruction seek access to a same page within the plurality of pages, and if so, to prevent TLB access by the subsequent instruction, and to utilize the results of the TLB access of a previous instruction for the current instruction.

### FIELD

The present invention relates to translation look-aside buffers.

### BACKGROUND

In a processor that supports paged virtual memory, data may be specified using virtual (or “logical”) addresses that occupy a virtual address space of the processor. The virtual address space may typically be larger than the amount of actual physical memory in the system. The operating system in these processors may manage the physical memory in fixed size blocks called pages.

To translate virtual page addresses into physical page addresses, the processor may search page tables stored in the system memory, which may contain the necessary address translation information. Since these searches (or “page table walks”) may involve memory accesses, unless the page table data is in a data cache, these searches may be time-consuming.

The processor may therefore perform address translation using one or more TLBs (translation lookaside buffers). A TLB is an address translation cache, i.e. a small cache that stores recent mappings from virtual addresses to physical addresses. The processor may cache the physical address in the TLB, after performing the page table search and the address translation. A TLB may typically contain the most commonly referenced virtual page addresses, as well as the physical page address associated therewith. There may be separate TLBs for instruction addresses (instructions-TLB or I-TLB) and for data addresses (data-TLB or D-TLB).

A TLB may be accessed to determine the physical address of an instruction, or the physical address of one or more pieces of an instruction. A virtual address may typically have been generated for the instruction, or the piece of an instruction. The TLB may search its entries to see if the address translation information for the virtual address is contained in any of its entries.

In order to obtain the address translation information for multiple subsequent instructions, or for multiple pieces of an instruction, the TLB may be accessed for each individual instruction, or for each of the multiples pieces of an instruction. This process may entail some power however, since each TLB access requires some consumption of power.

### SUMMARY

In one embodiment of the invention, a processor may include a memory, a TLB, and a TLB controller. The memory may be configured to store data in a plurality of pages. The TLB may be configured to search, when accessed by an instruction having a virtual address, for address translation information that allows the virtual address to be translated into a physical address of one of the plurality of pages, and to provide the address translation information if the address translation information is found within the TLB. The TLB controller may be configured to determine whether a current instruction and a subsequent instruction seek access to a same page within the plurality of pages, and if so, to prevent TLB access by the subsequent instruction. The TLB controller may also be configured to utilize the results of the TLB access of the current instruction for the subsequent instruction.

In another embodiment of the invention, a processor may include a memory, a TLB, and a TLB controller. The memory may be configured to store data in a plurality of pages. The TLB may be configured to search, when accessed by an instruction having a virtual address, for address translation information within the TLB that allows the virtual address to be translated into a physical address, and to provide the address translation information if the address translation information is found within the TLB. The TLB controller may be configured to determine whether a current instruction and a plurality of subsequent instructions seek access to a same page within the plurality of pages, and if so, to prevent TLB access by one or more of the plurality of subsequent instructions. The TLB controller may also be configured to utilize the results of the TLB access of the current instruction for one or more of the plurality of subsequent instructions.

In another embodiment of the invention, a processor may include a memory, and a TLB controller. The memory may be configured to store data in a plurality of pages. The TLB may be configured to search, when accessed by an instruction containing the virtual address, for address translation information that allows a virtual address to be translated into a physical address, and to provide the address translation information if the address translation information is found within the TLB. The processor may further include means for determining whether a current instruction and a subsequent instruction seek data access from a same page within the plurality of pages in the memory. The processor may further include means for preventing TLB access by the subsequent instruction, if the current instruction and the subsequent instruction seek data access from a same page within the plurality of pages in the memory. The processor may further include means for utilizing the results of the TLB access of the current instruction for the subsequent instruction.

In yet another embodiment of the invention, a method of controlling access to a TLB in a processor may include receiving a current instruction and a subsequent instruction. The method may include determining that the current instruction and the subsequent instruction seek access to a same page within a plurality of pages in a memory. The method may include preventing access to the TLB by the subsequent instruction. The method may include utilizing the results of the TLB access of the current instruction for the subsequent instruction.

In another embodiment of the invention, a processor may include a memory, a TLB, and a TLB controller. The memory may be configured to store data in a plurality of pages. The TLB may be configured to search, when accessed by an instruction having a virtual address, for address translation information within the TLB that allows the virtual address to be translated into a physical address, and to provide the address translation information if the address translation information is found within the TLB. The TLB controller may be configured to determine whether a current compound instruction and any number of subsequent pieces of that compound instruction seek access to a same page within the plurality of pages, and if so, to prevent TLB access by the one or more of the plurality of subsequent pieces of the compound instruction. The TLB controller may be configured to utilize the results of the TLB access for the first piece of the compound instruction for the plurality of subsequent pieces of that instruction.

### BRIEF DESCRIPTION OF THE DRAWINGS

FIG. 1 schematically illustrates a translational lookaside buffer (TLB), known in the art, that provides address translation information for virtual addresses.

FIG. 2 is a diagram of a multistage pipelined processor having a TLB controller configured to prevent multiple TLB accesses to a same page in memory.

### DETAILED DESCRIPTION

The detailed description set forth below in connection with the appended drawings is intended to describe various embodiments of the present invention, but is not intended to represent the only embodiments in which the present invention may be practiced. The detailed description includes specific details, in order to permit a thorough understanding of the present invention. It should be appreciated by those skilled in the art, however, that the present invention may be practiced without these specific details. In some instances, well-known structures and components are shown in block diagram form, in order to more clearly illustrate the concepts of the present invention.

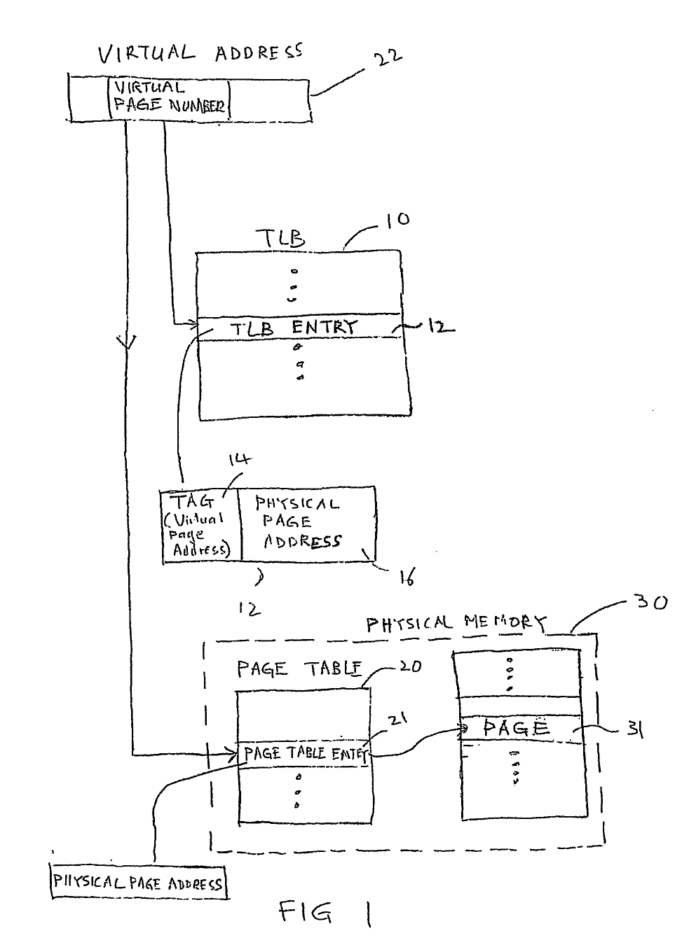

FIG. 1 schematically illustrates a conventional TLB that operates in a virtual memory system. As known in the art, in virtual memory systems mappings (or translations) may typically be performed between a virtual (or “linear”) address space and a physical address space. A virtual address space typically refers to the set of all virtual addresses 22 generated by a processor. A physical address space typically refers to the set of all physical addresses for the data residing in the physical memory 30, i.e. the addresses that are provided on a memory bus to write to or read from a particular location in the physical memory 30.

In a paged virtual memory system, it may be assumed that the data is composed of fixed-length units 31 commonly referred to as pages. The virtual address space and the physical address space may be divided into blocks of contiguous page addresses. Each virtual page address may provide a virtual page number, and each physical page address may indicate the location within the memory 30 of a particular page 31 of data. A typical page size may be about 4 kilobytes, for example, although different page sizes may also be used. The page table 20 in the physical memory 30 may contain the physical page addresses corresponding to all of the virtual page addresses of the virtual memory system, i.e. may contain the mappings between virtual page addresses and the corresponding physical page addresses for all the virtual page addresses in the virtual address space. Typically, the page table 20 may contain a plurality of page table entries (PTEs) 21, each PTE 21 pointing to a page 31 in the physical memory 30 that corresponds to a particular virtual address.

Accessing the PTEs 21 stored in the page table 20 in the physical memory 30 may generally require memory bus transactions, which may be costly in terms of processor cycle time and power consumption. The number of memory bus transactions may be reduced by accessing the TLB 10, rather than the physical memory 30. As explained earlier, the TLB 10 is an address translation cache that stores recent mappings between virtual and physical addresses. The TLB 10 typically contains a subset of the virtual-to-physical address mappings that are stored in the page table 20. A TLB 10 may typically contain a plurality of TLB entries 12. Each TLB entry 12 may have a tag field 14 and a data field 16. The tag field 14 may include some of the high order bits of the virtual page addresses as a tag. The data field 16 may indicate the physical page address corresponding to the tagged virtual page address.

When an instruction has a virtual address 22 that needs to be translated into a corresponding physical address, during execution of a program, the TLB 10 may be accessed in order to look up the virtual address 22 among the TLB entries 12 stored in the TLB 10. The virtual address 22 typically includes a virtual page number, which may be used in the TLB 10 to look up the corresponding physical page address.

If the TLB 10 contains, among its TLB entries, the particular physical page address corresponding to the virtual page number contained in the virtual address 22 presented to the TLB, a TLB “hit” occurs, and the physical page address can be retrieved from the TLB 10. If the TLB 10 does not contain the particular physical page address corresponding to the virtual page number in the virtual address 22 presented to the TLB, a TLB “miss” occurs, and a lookup of the page table 20 in the physical memory 30 may have to be performed. Once the physical page address is determined from the page table 20, the physical page address corresponding to the virtual page address may be loaded into the TLB 10, and the TLB 10 may be accessed once again with the virtual page address 22. Because the desired physical page address has now been loaded in the TLB 10, the TLB access results in a TLB “hit” this time, and the recently loaded physical page address may be generated at an output of the TLB 10.

A paged virtual memory system, as described above, may be used in a pipelined processor having a multistage pipeline. As known in the art, pipelining can increase the performance of a processor, by arranging the hardware so that more than one operation can be performed concurrently. In this way, the number of operations performed per unit time may be increased, even thought the amount of time needed to complete any given operation may remain the same. In a pipelined processor, the sequence of operations within the processor may be divided into multiple segments or stages, each stage carrying out a different part of an instruction or an operation, in parallel. The multiple stages may be viewed as being connected to form a pipe. Typically, each stage in a pipeline may be expected to complete its operation in one clock cycle. An intermediate storage buffer may commonly be used to hold the information that is being passed from one stage to the next. By way of example, a three stage pipelined processor may include the following stages: instruction fetch, decode, and execute; a four stage pipeline may include an additional write-back stage.

Pipelining may typically exploit parallelism among instructions in a sequential instruction stream. As a sequential stream of instructions, or a sequential stream of multiple pieces of a single compound instruction, moves through the stages of a pipeline, the instructions may access the TLB at a TLB access point in the pipeline. Each instruction may access the TLB in turn, in order to look up the virtual-to-physical address translation needed to carry out the memory data accesses requested by the instructions. In order to determine whether the virtual addresses of a sequential instruction stream (or of a sequential stream of multiple pieces of an instruction) are included among the TLB entries in a TLB, a common practice may be to access the TLB for each instruction in the stream, in turn, or for each piece of an instruction, in turn. This may entail considerable power penalty, however, since each TLB access burns power.

In one embodiment of an address translation system, the crossing of a page boundry for multiple subsequent instructions, or for multiple pieces of an instruction, may be determined prior to a TLB access point in the pipeline. If it is determined that no page boundry has been crossed, the multiple subsequent instructions (or pieces of an instruction) may be prevented from carrying out TLB accesses, thereby saving power and increasing efficiency.

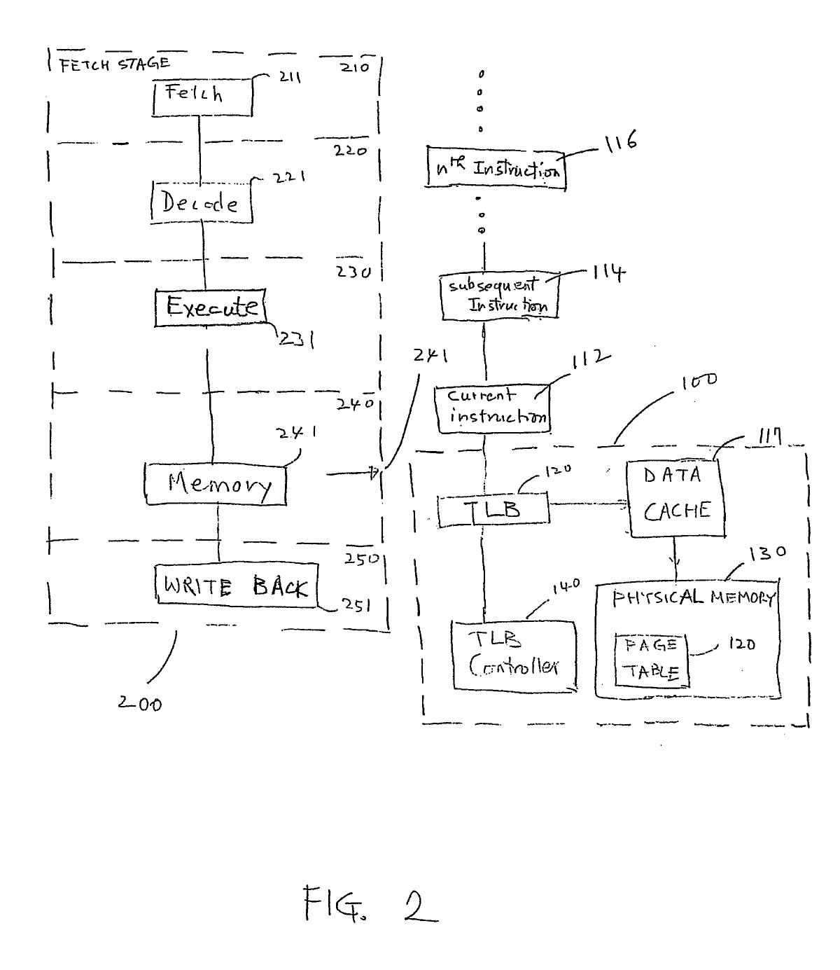

FIG. 2 is a functional diagram illustrating an address translation system 100 used in a pipelined processor having a multistage pipeline. In overview, the address translation system 100 includes a TLB 120, and a TLB controller 140 that controls the operation of the TLB 120, including the accesses to the TLB 120. In the illustrated embodiment, the TLB 120 may be a data-TLB (DTLB). The TLB controller 140 is configured to prevent subsequent accesses to the TLB 120, if it is determined that subsequent accesses to the TLB 120 seek data from a same page in memory. The TLB controller 140 may be part of a central processing unit (CPU) in the processor. Alternatively, the TLB controller 140 may be located within a core of a processor, and/or near the CPU of the processor.

The address translation system 100 may be connected to a physical memory 130, which includes a page table 120 that stores the physical page addresses corresponding to the virtual page addresses that may be generated by the processor. A data cache 117 that provides high speed access to a subset of the data stored in the main memory 110 may also be provided. One or more instruction registers may be provided to store one or more instructions.

An exemplary sequence 200 of pipeline stages is illustrated in FIG. 2. The sequence 200 of stages illustrated in FIG. 2 include: a fetch stage 210; a decode stage 220; an execute stage 230; a memory access stage 240; and a write back stage 250. The exemplary sequence in FIG. 2 is shown for illustrative purposes, and many other alternative sequences, having a smaller or a larger number of pipeline stages, are possible. The hardware may include at least one fetch unit 211 configured to fetch one or more instructions from the instruction memory; at least one decode unit 221 configured to decode the one or more instructions fetched by the fetch unit 211; at least one execute unit 231 configured to execute the one or more instructions decoded by the decode unit 221; at least one memory access unit 241 configured to access the memory 130; and at least one write back unit 251 configured to write back the data retrieved from the memory 130. The pipeline may include a TLB access point 241, at which one or more instructions may access the TLB 120 to search for address translation information.

FIG. 2 illustrates a current instruction 112 and a subsequent instruction 114 being received at appropriate stages of the pipeline. The current instruction 112 and the subsequent instruction 114 may be data access instructions. The address translation system 100 may include an address generator (not shown) that generates a virtual address for instruction 112 and a virtual address for instruction 114. Instruction 112 and instruction 114 may be consecutive instructions that seek sequential locations in the TLB 120 or locations which reside within the same page. Alternatively, instructions 112 and 114 may be multiple pieces of a single compound instruction.

If it is determined that one or more subsequent instructions, or subsequent pieces of an instruction, seek data access from a same page in the memory 130, TLB access by the subsequent instructions (or pieces of an instruction) may be prevented by the TLB controller 140. As explained earlier, this approach may save power and increase efficiency, compared to carrying out a TLB access to the TLB 120 for each and every instruction in order to determine whether the requisite address translation information can be found in the TLB 120.

In the illustrated embodiment, the TLB controller 140 is configured to determine whether the current instruction 112 and the subsequent instruction 114 seek access to data from a same page in the memory 130. For example, information regarding subsequent data accesses sought by one or more subsequent instructions (e.g. instruction 114 in FIG. 2) may be obtained by the TLB controller 140 from a current instruction (e.g. instruction 112 in FIG. 2). In one embodiment, the TLB controller 140 may be configured to figure out what the subsequent data accesses will be for one or more subsequent instructions following a current instruction, just by examining the current instruction itself, and extracting therefrom information regarding the data accesses sought by the subsequent instructions following the current instruction 112.

The information regarding subsequent data accesses may be provided by the type of the current instruction 112. By way of example, the instruction type of the current instruction 112 may be one of the following types: “load”, “store”, or “cache manipulation” Some types of instruction may define whether the CPU needs to go to the data cache 117 or to the main memory 130. In one embodiment, the current instruction 112 may be an instruction for an iterative operation whose data accesses have not yet reached the end of a page in the physical memory 130.

In one embodiment, the TLB controller 140 may be configured to determine the virtual address of the subsequent instruction 114 (that follows instruction 112), at a time point along the pipeline that is above the TLB access point 119. The TLB controller 140 may be configured to compare the virtual address of instruction 114 with the virtual address of instruction 112, in order to determine whether the virtual address of instruction 114 would seek access to the same page, compared to the page sought by the virtual address of instruction 112. In other words, the TLB controller 140 may compare the virtual addresses, in order to determine whether the page in memory to which access is sought by instruction 112 has the same physical page address, compared to the physical page address of the page in memory to which access is sought by instruction 114.

The TLB controller 140 may be configured to determine the virtual addresses of a plurality of subsequent instructions following instruction 112 at a point in the pipeline above the TLB access point 241. The TLB controller 140 may also be configured to compare the virtual addresses of the plurality of subsequent instructions with the virtual address of instruction 112, in order to determine whether the virtual addresses of the plurality of subsequent instructions would all seek access to the same page (i.e. the page in memory having the same physical page address), compared to the page sought by the virtual address of instruction 112.

If the TLB controller 140 determines that the current instruction 112 and one or more subsequent instructions seek access to data from a same page in the memory 130, the TLB controller 140 may prevent a TLB access by the one or more subsequent instructions, because the TLB controller 140 has obtained advance knowledge that the next several TLB accesses would all hit the same page in the memory 130. In other words, the TLB controller 140 determines prior to the TLB access point 241 whether a crossing of a page boundry occurs for the subsequent instructions (or the subsequent pieces of an instruction), and prevents TLB accesses from occurring, if no page boundry is crossed. A lot of power may be saved by preventing TLB accesses that may generate only repetitive and redundant information, by finding out before the TLB access point 241 that all these TLB accesses would just hit the same page in the physical memory 130 every time, i.e. just provide the same information.

The TLB controller 140 may be configured to use, for one or more subsequent instructions following the current instruction 112, the address translation information that was previously provided by the TLB 120 for the current instruction 112, if the TLB controller 140 determines that the subsequent instructions and the current instruction 112 seek data access from the same page in the memory 130.

In one embodiment, the TLB controller 140 may be configured to determine the relation between the virtual address of instruction 112, and the virtual addresses of each of a plurality of subsequent instructions that follow instruction 112, by recognizing the type of instruction, and how that particular type of instruction works. As one example, the TLB controller 140 may be able to determine, based on the instruction type of a current instruction, that each one of the plurality of subsequent instructions will be sequentially coded, e.g. will be seeking addresses characterized by a predetermined number (e.g. 4) of incremental bytes.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A processor comprising:
a memory configured to store data in a plurality of pages;
a translation lookaside buffer (TLB) configured to search, when accessed by an instruction having a virtual address, for address translation information that allows the virtual address to be translated into a physical address of one of the plurality of pages, and to provide the address translation information if the address translation information is found within the TLB; and
a TLB controller configured to determine whether a current instruction and a subsequent instruction seek access to a same page within the plurality of pages, and if so, to prevent TLB access by the subsequent instruction.

2. The processor of claim 1, wherein the current instruction includes information about the subsequent instruction, and wherein the TLB controller is further configured to use the information included in the current instruction in order to determine whether the current instruction and the subsequent instruction seek access to a same page within the plurality of pages.

3. The processor of claim 1, wherein the TLB controller is further configured to compare a virtual address generated for the current instruction with a virtual address generated for the subsequent instruction, in order to determine whether the current instruction and the subsequent instruction seek access to a same page within the plurality of pages.

4. The processor of claim 3, wherein the TLB controller is further configured to determine whether the virtual address generated for the current instruction and the virtual address generated for the subsequent instruction translate into physical addresses of a same page within the plurality of pages.

5. The processor of claim 2, wherein the TLB controller is further configured to use for the subsequent instruction an address translation information that was already provided by the TLB for the current instruction, if the memory access controller determines that the current instruction and the subsequent instruction seek data access from the same page within the plurality of pages.

6. The processor of claim 1, wherein the current instruction comprises an instruction for an iterative operation.

7. The processor of claim 1, wherein the current instruction and the subsequent instruction comprise consecutive pieces of a single compound instruction.

8. The processor of claim 1, wherein the TLB is configured to store a plurality of TLB entries, each one of the plurality of TLB entries including a virtual address, a physical address of one of the plurality of the pages in the memory, and address translation information for translating the virtual address into the physical address, and wherein the TLB is further configured to search within the plurality of TLB entries for the address translation information, when accessed by the instruction containing the virtual address.

9. The processor of claim 1, wherein the TLB controller is further configured to determine, prior to a TLB access point of the subsequent instruction, whether the current instruction and the subsequent instruction seek access to a same page within the plurality of pages.

10. The processor of claim 1, wherein the current instruction and the subsequent instruction comprise consecutive instructions that seek sequential accesses to the memory.

11. The processor of claim 1, wherein the processor comprises a multi-stage pipelined processor.

12. The processor of claim 11, wherein the multi-stage pipelined processor comprises at least a fetch stage, a decode stage, an execute stage, a memory stage, and a write-back stage.

13. The processor of claim 12, further comprising:
at least one fetch unit configured to fetch one or more instructions from the instructions register;
at least one decode unit configured to decode the one or more instructions fetched by the fetch unit; and
at least one execute unit configured to execute the one or more instructions decoded by the decode unit.

14. A processor comprising:
a memory configured to store data in a plurality of pages;
a TLB configured to search, when accessed by an instruction having a virtual address, for address translation information within the TLB that allows the virtual address to be translated into a physical address, and to provide the address translation information if the address translation information is found within the TLB; and
a TLB controller configured to determine whether a current instruction and a plurality of subsequent instructions seek access to a same page within the plurality of pages, and if so, to prevent TLB access by the one or more of the plurality of subsequent instructions.

15. A processor comprising:
a memory configured to store data in a plurality of pages;
a TLB configured to search, when accessed by an instruction containing the virtual address, for address translation information that allows a virtual address to be translated into a physical address, and to provide the address translation information if the address translation information is found within the TLB;
means for determining whether a current instruction and a subsequent instruction seek data access from a same page within the plurality of pages in the memory; and
means for preventing TLB access by the subsequent instruction, if the current instruction and the subsequent instruction seek data access from a same page within the plurality of pages in the memory.

16. A method of controlling access to a TLB in a processor, the method comprising:
receiving a current instruction and a subsequent instruction;
determining that the current instruction and the subsequent instruction seek access to a same page within a plurality of pages in a memory; and
preventing access to the TLB by the subsequent instruction.

17. The method of claim 16, wherein the current instruction includes information about the subsequent instruction, and further comprising using the information included in the current instruction to determine that the current instruction and the subsequent instruction seek access to the same page within the plurality of pages.

18. The method of claim 16, wherein the act of determining that the current instruction and the subsequent instruction seek access to a same page in a memory comprises generating a first virtual address for the current instruction and a second virtual address for the subsequent instruction, and comparing the first virtual address with the second virtual address.

19. The method of claim 18, wherein the act of comparing the first virtual address with the second virtual address comprises determining whether the first virtual address and the second virtual address translate into physical addresses that indicate a same page within the plurality of pages.

20. The method of claim 16, further comprising using for the subsequent instruction an address translation information that was already provided by the TLB for the current instruction, after determining that the current instruction and the subsequent instruction seek data access from a same page within the plurality of pages.

21. The processor of claim 1, further comprising a memory configured to store instructions in a plurality of pages.

22. The processor of claim 1, wherein the TLB controller is further configured to utilize a result of the TLB access of a previous instruction for the current instruction.

23. The processor of claim 1, wherein the processor comprises a plurality of levels of TLB.
